(19) United States
(12) Patent Application Publication
(10) Pub. No.: US 2026/0341022 A1
(43) Pub. Date: Oct. 29, 2026

(54) METHOD OF OPERATING INFORMATION PROCESSING APPARATUS AND INFORMATION PROCESSING APPARATUS

(71) Applicant: TOYOTA JIDOSHA KABUSHIKI KAISHA, Aichi-ken (JP)

(72) Inventors: Ashutosh KUMAR, Chuo-ku (JP); Quan KONG, Toshima-ku (JP); Norimasa KOBORI, Nakano-ku (JP)

(21) Appl. No.: 19/653,111

(22) Filed: Apr. 21, 2026

(30) Foreign Application Priority Data
Apr. 28, 2025 (JP) 2025-074799

(51) Int. Cl. G06V 20/40; G06F 40/40

(52) U.S. Cl. CPC G06V 20/41; G06F 40/40; G06V 20/46

(57) ABSTRACT

A method of operating an information processing apparatus, which includes an acquisition interface that acquires a video, an extractor that extracts an instance image of an object of interest from a global image representing a scene of the video, a video encoder that derives a first feature from the global image and derives a second feature from the instance image, and a text encoder that generates a first caption describing the global image based on the first feature and generates a second caption describing the instance image based on the second feature, includes adjusting the video encoder to generate, from the global image, the first feature that causes the first caption to approximate the second caption.

### CROSS-REFERENCE TO RELATED APPLICATION

This application claims priority to Japanese Patent Application No. 2025-074799, filed on Apr. 28, 2025, the entire contents of which are incorporated herein by reference.

### TECHNICAL FIELD

The present disclosure relates to a method of operating an information processing apparatus and an information processing apparatus.

### BACKGROUND

Vision large language models (VLLMs) are known as multimodal machine learning models. For an input video, VLLMs output a sentence or a caption describing the scene of the video. For example, Patent Literature (PTL) 1 discloses a system that learns to generate an output caption based on an input image and an input region thereof.

### CITATION LIST

### Patent Literature

PTL 1: JP 2019-008778 A

### SUMMARY

When a caption focusing on a specific instance is required in a video that contains multiple subjects or instances, failing to output such a caption may pose a risk of not providing sufficient information for understanding the scene of the video.

Hereinafter, a method of operating an information processing apparatus capable of outputting a more accurate caption will be disclosed.

A method of operating an information processing apparatus according to the present disclosure is a method of operating an information processing apparatus including:
an acquisition interface configured to acquire a video;
an extractor configured to extract an instance image of an object of interest from a global image representing a scene of the video;
a video encoder configured to derive a first feature from the global image, and derive a second feature from the instance image; and
a text encoder configured to generate a first caption describing the global image based on the first feature, and generate a second caption describing the instance image based on the second feature,
the method including adjusting the video encoder to generate, from the global image, the first feature that causes the first caption to approximate the second caption.

The method of operating an information processing apparatus according to the present disclosure makes it possible to output a more accurate caption.

### BRIEF DESCRIPTION OF THE DRAWINGS

In the accompanying drawings:

FIG. 1 is a diagram illustrating an example of a configuration of an information processing system;

FIG. 2 is a sequence diagram illustrating an example operation procedure of an information processing apparatus; and

FIG. 3 is a diagram illustrating an example of a scene and captions of a video.

### DETAILED DESCRIPTION

An embodiment will be described below.

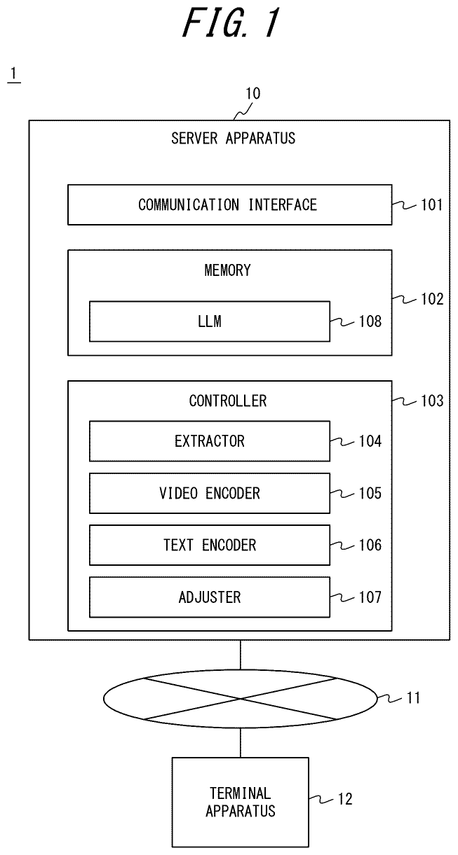

FIG. 1 is a diagram illustrating an example configuration of an embodiment. An information processing system 1 includes a server apparatus 10 and a terminal apparatus 12 that are communicably connected to each other via a network 11 to communicate information. In the information processing system 1, the server apparatus 10 performs information processing in response to various instructions sent from the terminal apparatus 12. The terminal apparatus 12 is, for example, one or more personal computers. The personal computer may include tablet devices, smartphones, and the like. The server apparatus 10 corresponds to the “information processing apparatus” in the present embodiment, for example, one or more server computers. The server apparatus 10 may be a single server computer, or may be multiple server computers that execute operations in the present embodiment in conjunction with each other. The network 11 may be, for example, a local area network (LAN), the Internet, an ad hoc network, a metropolitan area network (MAN), a mobile communication network, other networks, or any combination thereof.

In the present embodiment, the server apparatus 10 receives various instructions and information from the terminal apparatus 12 and generates captions corresponding to the video. The server apparatus 10 includes a communication interface 101, a memory 102, and a controller 103. The controller 103 has, as functional modules, an extractor 104, a video encoder 105, a text encoder 106, and an adjuster 107. These functional modules are realized by the operation of the controller 103 using programs and various information stored in the memory 102. Each functional module may be appropriately arranged on the two or more server computers when the server apparatus 10 is configured with two or more server computers.

In the server apparatus 10, the communication interface 101 functions as an acquisition unit that acquires video. The extractor 104 extracts instance images of an object of interest from global images that include scenes in the video. A scene is a series of frames that have temporal continuity in the video. The video encoder 105 derives first and second features (hereinafter referred to as global features and instance features, respectively) from the global image and the instance image. The text encoder 106 generates first and second captions (hereinafter referred to as global caption and instance caption, respectively) that describe the global image and the instance image based on the global features and instance features. Then, the adjuster 107 adjusts the video encoder 105 to generate global features such that the global caption approximates the instance caption from the global image. By using the global features generated from the new global image by the adjusted video encoder 105, the text encoder 106 can generate a global caption that describes the instance of interest. Therefore, when a caption focusing on a specific instance is required in a video containing multiple instances, it becomes possible to output a more accurate caption.

The communication interface 101, memory 102, and controller 103 of the server apparatus 10 are configured as follows.

The communication interface 101 includes one or more interfaces for communication. The interfaces for communication include, for example, a LAN interface. The communication interface 101 receives information to be used for operations of the server apparatus 10 and transmits information obtained by the operations of the server apparatus 10. The server apparatus 10 is connected to the network 11 by the communication interface 101, and communicates information with the terminal apparatus 12 via the network 11.

The memory 102 includes, for example, one or more semiconductor memories, one or more magnetic memories, one or more optical memories, or a combination of at least two of these types, to function as a main memory, an auxiliary memory, or a cache memory. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 102 stores information to be used for operations of the controller 103 and information obtained by operations of the controller 103. The memory 102 stores an LLM (Large Language Model) 108. LLM 108 is a natural language processing model trained on a large amount of document data, based on a transformer structure, which outputs response sentences, text summaries, dialogue sentences, etc., considering the input context.

The controller 103 includes one or more processors, one or more dedicated circuits, or a combination thereof. The processors are general purpose processors, such as central processing units (CPUs), or dedicated processors, such as graphics processing units (GPUs), specialized for specific processing. The dedicated circuits are, for example, field-programmable gate arrays (FPGAs), application specific integrated circuits (ASICs), or the like. The controller 103 executes information processing related to operations of the server apparatus 10 while controlling components of the server apparatus 10.

The functions of the server apparatus 10 are realized by a processor included in the controller 103 executing a control program stored in the memory 102. The control program is a program for causing the processor to function as the controller 103. Some or all of the functions of the server apparatus 10 may be realized by a dedicated circuit included in the controller 103. The control program may be stored on a non-transitory recording/storage medium readable by the controller 103, and be read from the medium by the controller 103.

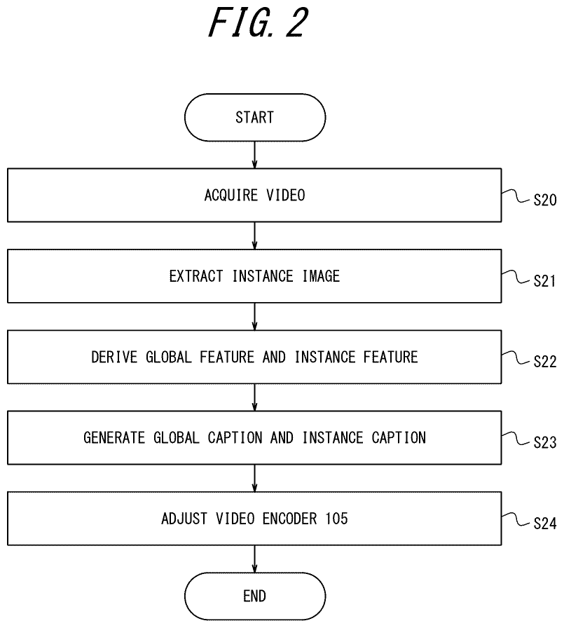

FIG. 2 is a flowchart illustrating an example of an operation procedure of the server apparatus 10. The procedure in FIG. 2 is a procedure for adjusting the video encoder 105 executed by the controller 103. For example, a user sends instructions to the server apparatus 10 to operate it by operating the terminal apparatus 12, and in response to that instruction, the controller 103 executes the procedure in FIG. 2.

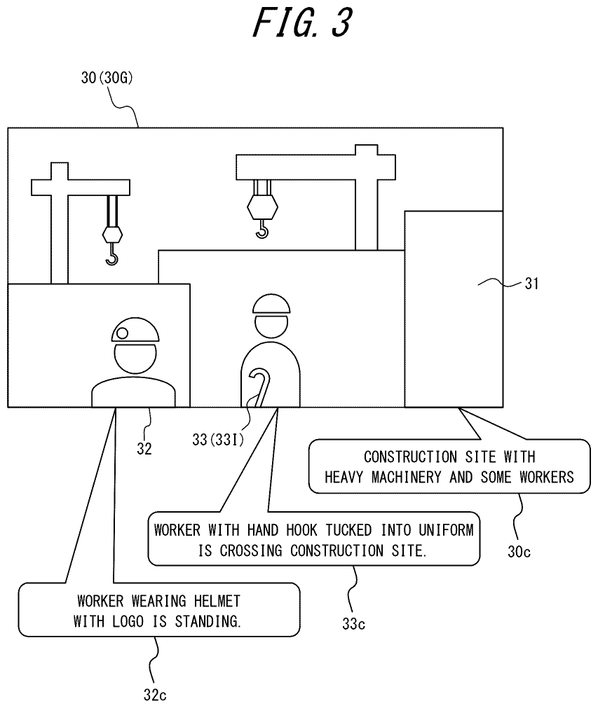

The controller 103 acquires video (S20). The controller 103 acquires video generated in advance by imaging, etc., from the terminal apparatus 12 or other servers via the communication interface 101. For example, as shown in FIG. 3, video including scene 30 is acquired. Scene 30 includes, for example, workers 32 and 33 at a construction site 31. The entirety of scene 30, or a part of scene 30 including the construction site 31, workers 32 and 33 corresponds to the global image 30G.

Then, the controller 103 extracts the instance image by the extractor 104 (S21). The extractor 104 extracts subjects from the global image 30G according to any algorithm using bounding boxes and determines the object of interest from the extracted subjects. The subjects included in the global image 30G are pre-labeled with identification information, and the object of interest is determined based on the identification information. The extractor 104 extracts the instance image containing the subject of interest. For example, an image of a bounding box including worker 33 is extracted from the global image 30G as instance image 331.

Then, the controller 103 derives global features and instance features corresponding to the global image 30G and instance image 331, respectively, using the video encoder 105 (S22). The video encoder 105 is a neural network model pre-trained using a large-scale video dataset to output vector representations that characterize the scenes of the video. The video encoder 105 derives vector-form features that characterize the global image 30G as global features. Additionally, the video encoder 105 derives vector-form features that characterize the instance image 301 as instance features.

Then, the controller 103 generates global captions and instance captions that describe the global image 30G and instance image 331, respectively, from the global features and instance features using the text encoder 106 (S23). The text encoder 106 outputs natural language using a vector representation as input context, for example, using LLM 108. The text encoder 106 generates a global caption to describe the global image 30G based on global features. Additionally, the text encoder 106 generates an instance caption to describe the instance image 301 based on instance features, for example, using LLM 108. For example, as shown in FIG. 3, a caption 30c such as “construction site with heavy machinery and some workers” is generated as a global caption to describe the global image 30G. Alternatively, a caption 32c such as “worker wearing helmet with logo is standing” that describes the worker 32 included in the global image 30G may be generated as a global caption. Alternatively, a caption 33c such as “worker with hand hook tucked into uniform is crossing construction site” that describes the worker 33 included in the global image 30G may be generated as a global caption. On the other hand, a caption 33c such as “worker with hand hook tucked into uniform is crossing construction site” is generated as an instance caption to describe the instance image 331.

Next, the controller 103 adjusts the video encoder 105 by the adjuster 107 to generate global features such that the global caption approximates the instance caption from the global image 30G (S24).

First, the adjuster 107 generates a feature vector indicating the similarity between instance features and global features through cross-attention processing according to the following formula (1), for example, where the instance features are Query (Q), and the global features are Key (K) and Value (V).

$$Attention ( Q , K , V ) = softmax ( \frac{{QK}^{T}}{\sqrt{{d}_{k}}} ) V \qquad Formula ( 1 )$$

Next, the adjuster 107 performs contrastive learning on the feature vector obtained from the above formula (1). The adjuster 107 applies, for example, VTC (Video-Text Contrastive) to evaluate the combination of instance captions and global captions with discrete scores, adjusting the feature vector so that the similarity of the combination of instance captions and global captions is maximized. The similarity is, for example, a discrete score such as Positive, Neutral, and Negative. For example, in the case of FIG. 3, the combination of caption 33c as an instance caption and caption 33c as a global caption is evaluated as Positive because the sentences match each other, while the combination of caption 33c as an instance caption and caption 32c as a global caption is evaluated as Neutral because the sentences do not match each other. The combination of caption 33c as an instance caption and captions based on other scenes is evaluated as Negative.

By the above procedure, when the video encoder 105 is adjusted, it generates captions corresponding to newly input video, and the video encoder 105 generates global features similar to the instance features of the object of interest, allowing the text encoder 106 to generate a global caption that describes the object of interest based on those global features. Therefore, even when a caption focusing on a specific instance is required in a video containing multiple instances, it becomes possible to output a more accurate caption.

According to the present embodiment, even when a large amount of information is contained in the scene of the video during viewing, it is possible to obtain captions focusing on specific individuals, events, etc., from the entire scene. Thus, a more comprehensive understanding of the video becomes possible.

In the above, the server apparatus 10 was described as corresponding to the “information processing apparatus” and its operation procedure. However, the terminal apparatus 12 may execute more than part of the operations of the server apparatus 10, and the server apparatus 10 and terminal apparatus 12 may work together to constitute the “information processing apparatus.”

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A method of operating an information processing apparatus comprising:
an acquisition interface configured to acquire a video;
an extractor configured to extract an instance image of an object of interest from a global image representing a scene of the video;
a video encoder configured to derive a first feature from the global image, and derive a second feature from the instance image; and
a text encoder configured to generate a first caption describing the global image based on the first feature, and generate a second caption describing the instance image based on the second feature,
the method comprising adjusting the video encoder to generate, from the global image, the first feature that causes the first caption to approximate the second caption.

2. The method according to claim 1, comprising adjusting the video encoder using cross-attention in which the second feature corresponds to Query and the first feature corresponds to Key and Value.

3. The method according to claim 1, comprising adjusting the video encoder using a loss function corresponding to a similarity between the first caption and the second caption.

4. An information processing apparatus comprising:
the acquisition interface, extractor, and text encoder; and
the video encoder configured to be adjusted by the method according to claim 1.
